(19) United States
(12) Patent Application Publication
(10) Pub. No.: US 2026/0139804 A1
(43) Pub. Date: May 21, 2026

(54) OPTICAL SYSTEM FOR UNIFORM ILLUMINATION OF A TARGET AREA

(71) Applicant: ABL IP Holding LLC, Atlanta, GA (US)

(72) Inventors: Qi Ai, Peachtree City, GA (US); Gregory Frankiewicz, Elmhurst, IL (US); Jie Chen, Decatur, GA (US); John G. Serra, Pingree Grove, IL (US)

(21) Appl. No.: 18/949,098

(22) Filed: Nov. 15, 2024

(51) Int. Cl. F21S 8/02; F21V 3/04; F21V 5/02; F21V 5/04; F21Y 115/10

(52) U.S. Cl. CPC F21S 8/026; F21V 3/049; F21V 5/02; F21V 5/045; F21Y 2115/10

(57) ABSTRACT

An optical system is adapted to direct light rays towards a target area. The system includes a reflector with an optical chamber having an upper opening, a lower opening, a chamber axis, and a reflective inner surface. The upper opening receives light from a light source. The reflective inner surface directs the light rays towards the lower opening. A lens extending within a lens plane is oriented at a first angle relative to the chamber axis. The lens includes an input face and an output face opposite the light input face. The lens includes a first set of prisms on the input face and configured to bend the light relative to the optical axis and toward a target area, and a second set of prisms oriented at an angle relative to the first set of prisms and configured to spread the light laterally relative to the target area.

### FIELD OF DISCLOSURE

The present disclosure relates to optical systems, light fixtures that use such optical systems, and methods of controlling illumination of a target area with such optical systems.

### BACKGROUND

Downlight fixtures are used for illuminating a target area such as a portion of a floor, a wall, or other objects. In situations where the emitted light is desired to be directed in directions other than directly downwardly from the fixture (such as onto a wall), light fixtures have traditionally needed to be customized for such applications. In many applications, the light fixtures themselves or components within them have been angularly oriented relative to vertical to focus or pre-aim light from a light source toward a desired location to be illuminated. Such light fixtures have included a tiltable bracket, angular attachment means, or a reflective chamber having a particular form factor to facilitate a specified angular orientation to illuminate a target area. Such customized fixtures are not universal but rather serve the single, dedicated purpose of directing light off-vertical from the fixture.

### BRIEF SUMMARY

The present disclosure relates to optical systems, lighting systems, lighting fixtures and methods of providing uniform illumination of a target area. An optical system can be adapted to direct towards a target area light rays from a light source having an optical axis. The optical system can include a reflector and a lens angularly coupled to the reflector and configured to bend light towards a target area. The reflector defines an optical chamber comprising an upper opening, a lower opening, a chamber axis extending between the upper opening and the lower opening, and a reflective inner surface. The upper opening can be adapted to receive the light rays and the reflective inner surface is adapted to direct the light rays towards the lower opening. The lens can extend within a lens plane oriented at a first angle relative to the chamber axis. The lens can include a light input face; a light output face opposite the light input face; a first set of prisms provided on the light input face and configured to bend the light rays such that the light rays exit the lens at an exit angle relative to the optical axis and in a direction towards the target area; and a second set of prisms oriented at a second angle relative to the first set of prisms and configured to spread the light rays laterally relative to the target area.

In some embodiments, each prism of the first set of prisms extends linearly along a first lens axis, and each prism of the second set of prisms extends linearly along a second lens axis oriented at the second angle relative to the first lens axis. In some embodiments, the second angle is substantially 90°. In some embodiments, the second set of prisms is provided on the light output face of the lens. In some embodiments, the second set of prisms may be provided on the light input face of the lens.

In some embodiments, the first set of prisms can be distributed in a plurality of rows, and the second set of prisms extend between and at the second angle between adjacent prisms of the first set of prisms. The exit angle of the light can be between 1° and 60°, inclusive, relative to the nadir.

In some embodiments, each prism of the first set of prisms and each prism of the second set of prisms comprises a prism height and a prism angle and wherein at least some prisms of the first set of prisms are asymmetrical about their height and/or a first lens axis. In some embodiments, at least some prisms of the second set of prisms are asymmetrical about their height. The second set of prisms can be symmetrical about a second lens axis. In some embodiments, the prism height and the prism angle of each prism of the second set of prisms are identical. In some embodiments, at least one of the prism height or the prism angle is different between a first prism subset of the first set of prisms and a second prism subset of the first set of prisms such that the first and second prism subsets are configured to bend the light rays at different angles. In some embodiments, the prism angle of each prism of the first set of prisms can be between 0° and 60°, inclusive, and wherein the prism angle of each prism of the second set of prisms can be between 0° and 60°, inclusive.

In some embodiments, the optical chamber has a frustoconical shape that is asymmetrical about the chamber axis. In some embodiments, the lower opening of the optical chamber can extend in a plane that is angled relative to the chamber axis. In some embodiments, the optical chamber is asymmetrical about the chamber axis and comprises, in cross-section, a first chamber sidewall and an opposing second chamber sidewall that is longer than the first chamber sidewall. In some embodiments, the first chamber sidewall and the second chamber sidewall can extend at different angles relative to the chamber axis. In some embodiments, the reflective inner surface of the optical chamber can be configured to at least partially collimate the light.

In some embodiments, the optical system can further include a diffusing film provided on the light output face of the lens.

In some embodiments, the chamber axis can be adapted to extend parallel to the optical axis. In some embodiments, the optical axis and the chamber axis are colinear. In some embodiments, the upper opening of chamber extends in a first plane that is angled relative to a second plane of the lower opening, wherein the angle between the first plane and the second plane is in a range between 0° to 50°, inclusive.

The forgoing general description of the illustrative implementations and the following detailed description thereof are merely exemplary aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values or dimensions illustrated in the accompanying graphs and figures are for illustration purposes only and can or cannot represent actual or preferred values or dimensions. Where applicable, some or all features cannot be illustrated to assist in the description of underlying features. In the drawings:

FIG. 1 illustrates an exploded view of a light fixture including an optical system, according to various embodiments;

FIG. 2A illustrates a bottom perspective view of the assembled light fixture of FIG. 1;

FIG. 2B illustrates a top perspective view of the light fixture of FIG. 2A;

FIG. 3 illustrates a cross-sectional view of the light fixture of FIG. 2A;

FIG. 4A illustrates a bottom perspective view of the optical chamber housing of the optical system of FIG. 1;

FIG. 4B illustrates a bottom plan view of the optical chamber housing of FIG. 4A;

FIG. 4C illustrates a bottom perspective view of an example geometry of the optical chamber of FIG. 4A;

FIG. 4D illustrates a side elevation view of the example geometry of FIG. 4C;

FIG. 5A illustrates a top perspective view of an embodiment of a lens for use in the optical system of FIG. 1;

FIG. 5B illustrates a bottom perspective view of the lens of FIG. 5A;

FIG. 5C illustrates a top plan view of the lens of FIG. 5A;

FIG. 5D illustrates a bottom plan view of the lens of FIG. 5A;

FIG. 5E illustrates a side elevation view of the lens of FIG. 5A;

FIG. 6 is a light ray diagram illustrating interaction of light with the light input face of the lens of FIG. 5A;

FIG. 7A illustrates another embodiment of a lens for use in the optical system of FIG. 1;

FIG. 7B illustrates an enlarged view of a portion of the lens of FIG. 7A;

FIG. 8A illustrates illumination of a wall portion using the light fixture of FIG. 1;

FIG. 8B illustrates a light distribution of the light fixture shown in FIG. 8A;

FIG. 9A illustrates a light distribution associated with the light source of the light fixture in FIG. 1;

FIG. 9B illustrates a light distribution achieved by the optical chamber of the light fixture in FIG. 1;

FIG. 9C illustrates a light distribution achieved by the first set of prisms of the lens in FIGS. 7A and 7B;

FIG. 9D illustrates a light distribution achieved by the first set of prisms and the second set of prisms of the lens in FIGS. 7A and 7B;

FIGS. 10A-10D illustrate light distributions associated with the light source, the optical chamber, the first set of prisms of the lens, and the second set of prisms of the lens, respectively, of the light fixture of FIG. 1 within an enclosed spaced, according to various embodiments;

FIGS. 11A-11B illustrate a first light distribution associated with use of a first diffuser in the light fixture of FIG. 1 and corresponding distribution on a wall portion using the light fixture of FIG. 1;

FIGS. 12A-12B illustrate a second light distribution associated with use of a second diffuser in the light fixture of FIG. 1 and corresponding distribution on a wall portion using the light fixture of FIG. 1;

FIG. 13A illustrates a top perspective view of an installation of the light fixture of FIG. 1 in a ceiling, according to some embodiments;

FIG. 13B illustrates a bottom plan view of the installation of FIG. 13A;

FIG. 14A illustrates a top perspective view of another example of a light fixture, according to some embodiments; and

FIG. 14B illustrates a bottom plan view of an installation of the light fixture of FIG. 14A in a ceiling.

### DETAILED DESCRIPTION

The description set forth below in connection with the appended drawings is intended as a description of various embodiments of the disclosed subject matter and is not necessarily intended to represent the only embodiment(s). In certain instances, the description includes specific details for the purpose of providing an understanding of the disclosed embodiment(s). However, it will be apparent to those skilled in the art that the disclosed embodiment(s) can be practiced without those specific details. In some instances, well-known structures and components can be shown in block diagram form, omitted, or simplified in order to avoid obscuring the concepts of the disclosed subject matter.

The present disclosure provides optical systems configured to angle light beams onto a target area. The optical systems can include easily interchangeable optical components (e.g., a lens or a reflector). The optical systems can be configured to retrofit or convert an existing downlight fixture (e.g., illuminating a floor portion) to one configured to evenly illuminate a target area (e.g., a wall portion). Furthermore, the optical system can provide efficient or maximum utilization of available light for illuminating the target area with minimum wastage or light leakage. For example, a light fixture employing the optical systems described herein can achieve more than 65% light utilization for uniformly illuminating a wall portion. In some embodiments, at least 65% of the light emitted from the optical system exits the system in a direction toward a target area and less than 35% of the emitted light is emitted in a direction away from the intended target area. Embodiments herein describe optical systems for light fixtures that provide several benefits such as improved interchangeability, better light utilization, compact design, etc. as compared to existing lighting fixtures for wall-wash applications.

In various embodiments, an optical system herein can include a lens containing at least two set of prisms oriented at an angle relative to each other. The optical system can include a reflector that defines an optical chamber having a reflective inner surface configured to direct and/or narrow and/or collimate light from a light source onto the lens. The light can be received by the lens, and one set of prisms can bend the light in a direction toward the target area and the other set of prisms can further laterally spread the light across the target area. A diffusing layer can be provided at the light exit side of the lens to provide uniform illumination on a target area (e.g., a wall). The optical system can be used with an LED light engine that is facing downwardly, while providing asymmetric distribution on the wall with less light escaping away from the wall.

Advantageously, the lens can control bending of the light in a specified direction so that the shape of the reflective chamber can be simplified or made compact for manufacturing. For example, the reflective chamber can be a specular metal cone having an outer plastic sleeve. A compact sized reflective chamber can offer more space for mechanical mounting features for the light fixture while providing efficient illumination. In addition, the lens appearance may be improved by increasing a number of prisms or making prisms smaller in size. When viewed through a diffuser, smaller prisms can provide improved aesthetic appearance and break a light source image.

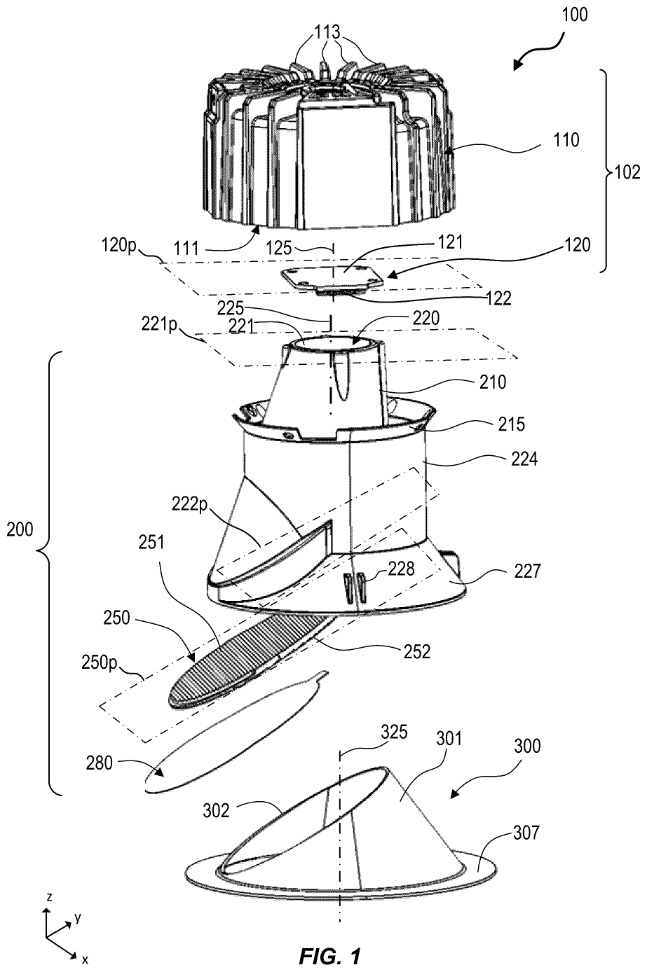

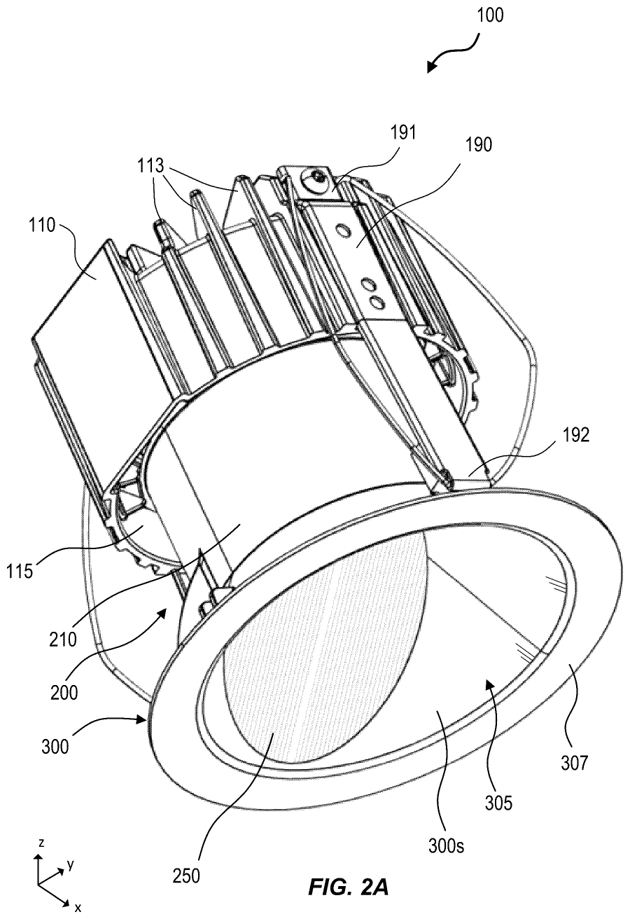

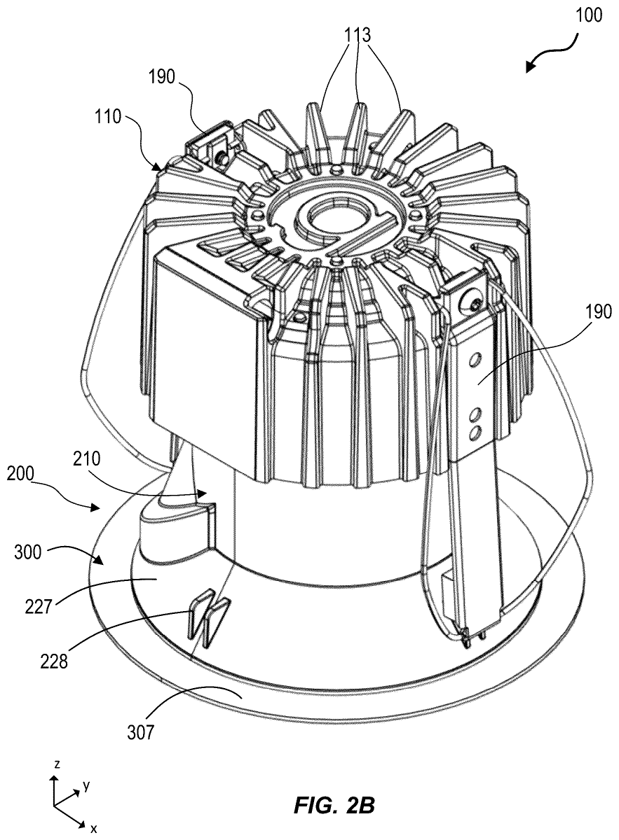

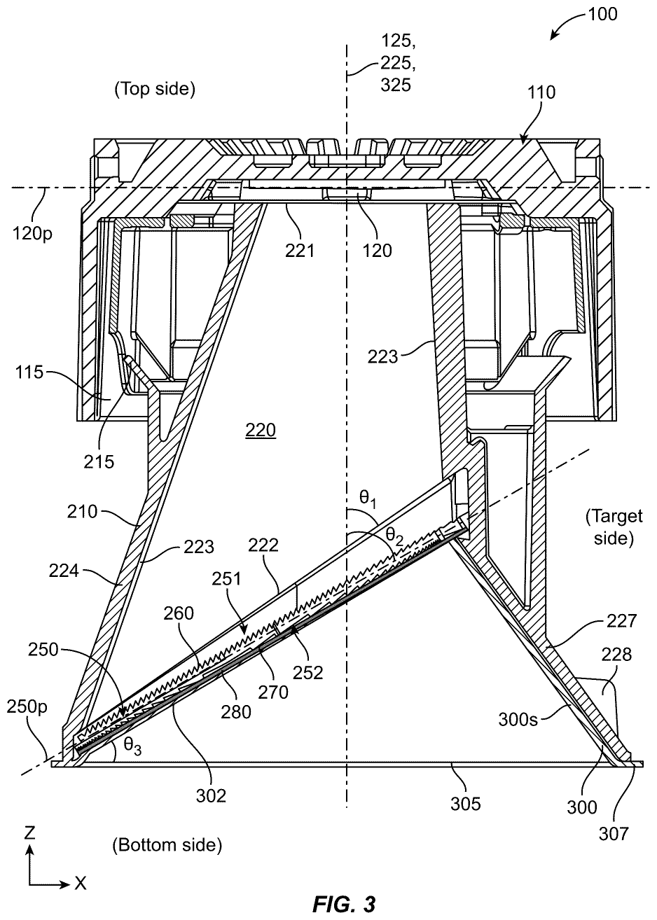

Referring now to the drawings, in which similar identifiers refer to similar elements, FIG. 1 illustrates an exploded view of a light fixture 100, and FIGS. 2A-2B and FIG. 3 illustrate the light fixture 100 in an assembled state, according to various embodiments. The light fixture 100 can include a light engine 102 that includes a heat sink 110 and a light source 120. In some embodiments, the heat sink 110 can have a cavity 111. One or more components of the light fixture 100 can be coupled to or at least partially housed within the cavity 111. For example, one or more coupling features, including but not limited to, a mounting plate, a retention ring (e.g., 115 in FIG. 2A) having coupling features like slots, tabs, fastener holes, or other features may be provided within the cavity 111. The heat sink 110 can include a plurality of fins 113 to facilitate convective cooling of heat dissipated through the heat sink 110. For example, the heat sink 110 can be used to dissipate heat generated by the light source 120 during operation. It can be understood that other types of heat sinks or heat dissipating system may be used without limiting the scope of the present disclosure.

In various embodiments, the light source 120 can include a printed circuit board (PCB) 121 with LEDs 122 mounted thereon. The present disclosure is not limited to LED light sources on a PCB 121, and other light sources may be used. The light source 120 can be mounted to the heat sink 110, such as within the cavity 111. In some embodiments, the printed circuit board 121 is mounted (e.g., via screws, adhesive, or other fasteners) to the heat sink 110. The light source 120 can include an optical axis 125. The optical axis 125 may pass through a center of the light source 120 and extend perpendicular to the PCB 121. In various embodiments, the optical axis 125 of the light source 120 can be substantially aligned and/or parallel to a central axis (chamber axis 225, introduced below) of the optical system 200. The light source 120 may lie in a light source plane 120p. The light source plane 120p can be a perpendicular to the optical axis 125. In some installation, the optical axis 125 will be substantially aligned with and/or extend parallel to a vertical axis (e.g., z-axis) or to nadir. The light source plane 120p can be a horizontal plane or a plane parallel to a ceiling. The light source 120 can have a wide light distribution such as a Lambertian distribution, for example. The light distribution of the light source 120 can be modified, however, by an optical system to provide an asymmetrical light distribution directed toward a target area. For example, the optical system can be configured to provide a uniform light distribution onto a wall located adjacent the light fixture 100.

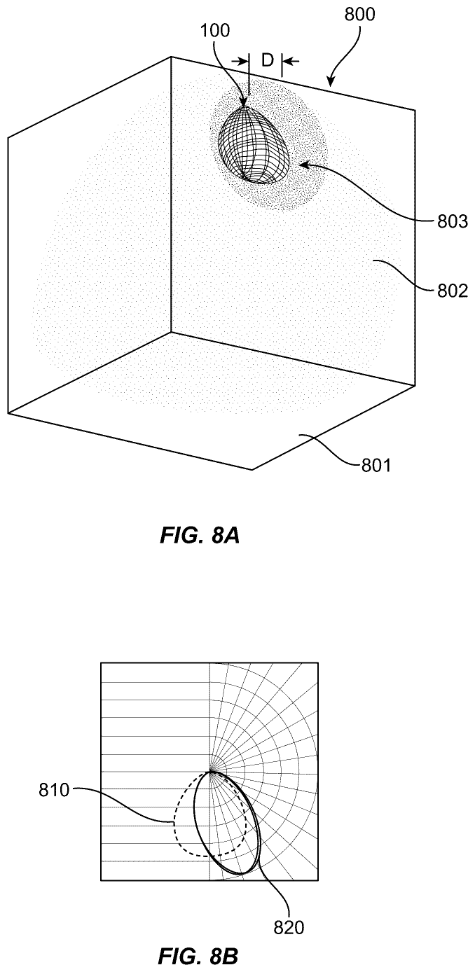

In various embodiments, the light fixture 100 can include an optical system 200 configured to channel and direct light to a target area. For example, light emitted by the light source 120 can be received within the optical system 200, which channels and directs the light downward and further bends the light towards a target area to evenly illuminate the target area (e.g., a wall portion shown in FIG. 8A). In various embodiments, the optical system 200 can be configured to bend the light at an angle relative to nadir (e.g., in a vertically upward direction) toward the target area and further spread the light to evenly illuminate the target area. In some embodiments, the optical system 200 can further include a trim 300 to impart a polished aesthetic appearance to the light fixture 100 and/or provide additional optical functions.

In various embodiments, the optical system 200 can include an optical system housing 224 that defines/houses/supports other components on the optical system 200, such as a reflector 210 and a lens 250. When the optical system housing 224 is attached to the light engine 102, the light source 120 is positioned to emit light into a first side (e.g., a top side) of the reflector 210 and the lens 250 is positioned at a second side (e.g., a bottom side) opposite the first side of the reflector 210. In various embodiments, the lens 250 can be angularly positioned relative to the reflector 210 at the second side (see FIGS. 2A and 3). In the illustrated embodiment, the optical system housing 224 can be configured to couple to the light engine 102 such that the reflector 210 is positioned to receive light from the light source 120 and direct the light to the lens 250. The reflector 210 and the lens 250 are further discussed in detail below.

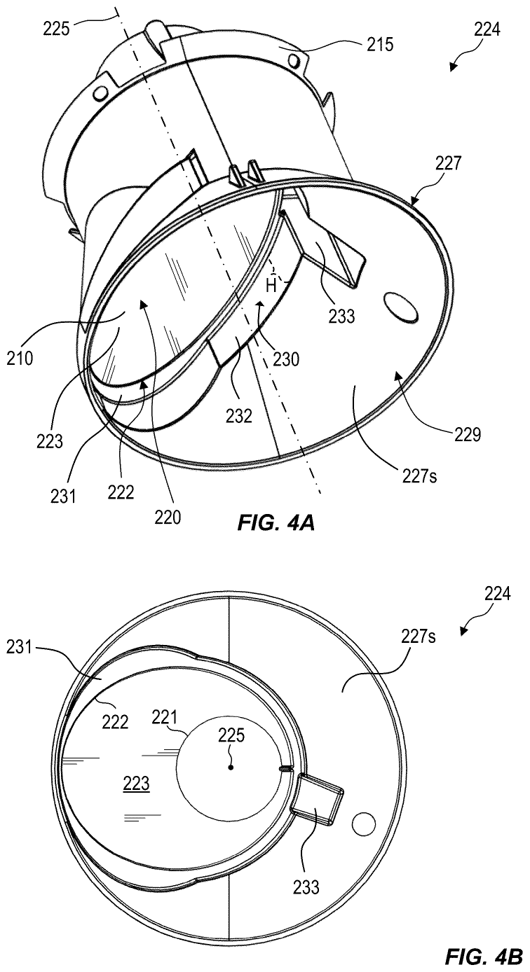

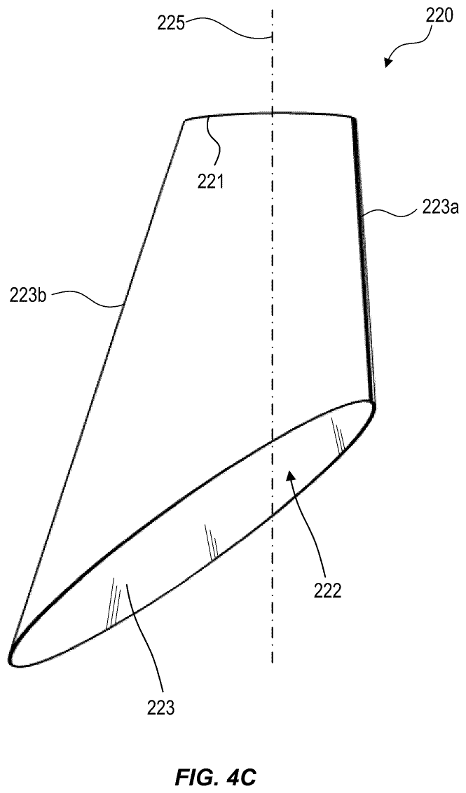

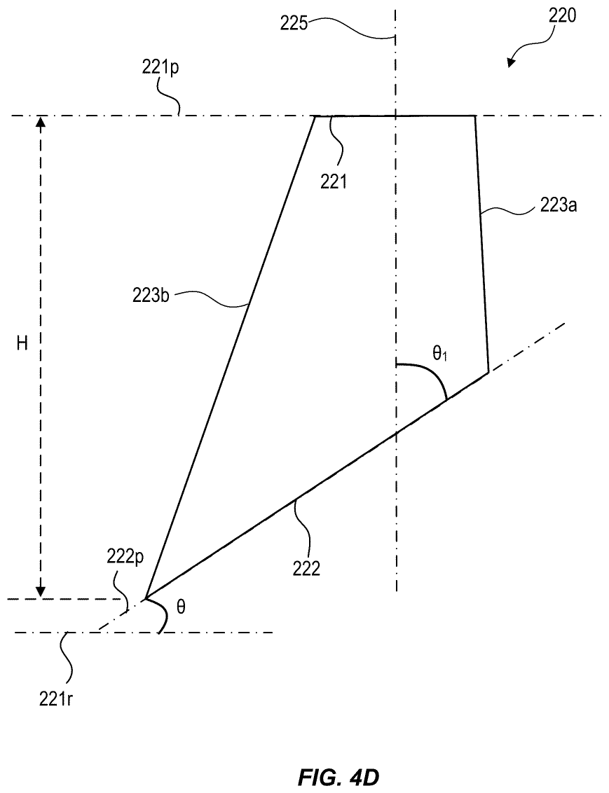

Referring to FIGS. 1 and 4A-4C, the reflector 210 can define an optical chamber 220 including a first opening 221, a second opening 222, a reflective inner surface 223, and a chamber axis 225. In some embodiments, the first opening 221 can be an upper opening configured to align with or receive the light source (e.g., 120). The first opening 221 can be adapted to receive the light beams from at least one light source 120. The second opening 222 can be a lower opening positioned more distal the light source 120 than the first opening 221. The chamber axis 225 can pass through a center point of the first opening 221 and extend between the first opening 221 and the second opening 222. In some embodiments, the chamber axis 225 aligns with and/or extends parallel to the optical axis 125.

FIGS. 3 and 4C-4D illustrate one possible geometry of the optical chamber 220. In the non-limiting, illustrated embodiment, the optical chamber 220 has a truncated conical shape. This conical shape of the optical chamber 220 can create a focused beam of light while directing the light from the first opening 221 to the second opening 222. In some embodiments, the optical chamber can have an asymmetric shape. For example, as shown in FIGS. 4C-4D, the optical chamber 220 has an asymmetrical frustoconical shape such that, in cross-section, a first chamber sidewall 223a is shorter than an opposing second chamber sidewall 223b. The first chamber sidewall 223a can (but does not have to) extend at a different angle than the second chamber sidewall 223b relative to the chamber axis 225. In some embodiments, the first chamber sidewall 223a may be positioned closer to a wall or other target area to be illuminated, and the second chamber sidewall 223b can direct light from the light source 120 towards the lens 250.

Referring to FIG. 4B, the first opening 221 of the optical chamber 220 can have a circular shape. However, the first opening 221 can be adapted to a different shape such as an oval shape, a rectangular shape, a square shape, or other shapes without limiting the scope of the present disclosure. The second opening 222 of the optical chamber 220 may have, but does not have to have, an oval shape, as best seen in FIG. 4B. In some embodiments, the first opening 221 can extend along a first plane 221p and the second opening 222 can extend along a second plane 222p oriented at an angle relative to the first plane 221p of the first opening 221, as best seen in FIG. 4D. In FIG. 4D, the angle θ is shown relative to a reference plane 221r (parallel to the first plane 221p) to illustrate the angular relationship between the first plane 221p and the second plane 222p. The angle θ makes the lens 250 tilted and only visible from the trim 300. This can beneficially reduce the glare of the lens 250 and improve visual appearance. In some embodiments, the angle θ can be in a range from 0° to 50°, inclusive. Additionally or alternatively, the angular relationship between the first opening 221 and the second opening 222 can be defined relative to the optical axis 125, as discussed below.

In various embodiments, the first plane 221p of the first opening 221 can extend perpendicular to the chamber axis 225, and the second plane 222p of the second opening 222 can be angled (e.g., at the angle θ₁) relative to the chamber axis 225, as best seen in FIG. 4D. In some embodiments, the angle θ₁ can be defined as 90°-θ and can be between 40° to 90°, inclusive.

In the illustrated embodiments, the chamber axis 225 of the optical chamber 220 can pass through a center of the first opening 221 and extend perpendicular to the first plane 221p of the first opening 221. Due to the asymmetric shape of the optical chamber 220, centers of the first opening 221 and the second opening 222 may be offset from each other. Hence, the chamber axis 225 may not necessarily pass through a center of the second opening 221. The reflector 210 may be provided within the optical system housing 224 such that, when the optical system housing 224 is mounted to the light engine 102, the chamber axis 225 is substantially aligned and/or extends parallel with the optical axis 125 of the light source 120. In some embodiments, the chamber axis 225 can be colinear with the optical axis 125 (i.e., the light source 120 is centered within the first opening 221). In this way, the optical chamber 220 need not be tilted or angled relative to the light source 120 so as to pre-aim emitted light onto a target area.

Referring to FIGS. 4A and 4C, the reflective inner surface 223 can be adapted to direct the light beams entering through the first opening 221 towards the second opening 222. The reflective inner surface 223 can be an inner circumferential surface extending between the first opening 221 and the second opening 222. In some embodiments, the reflective inner surface 223 has an asymmetric conical shape that directs the light from the first opening 221 towards the second opening 222 through the optical chamber 220 such that the light exits through the angularly positioned second opening 222. The reflective inner surface 223 narrows and focuses the emitted light onto the lens 250 due to depth, dimensions, and possibly shape of the sides 223a and 223b of the optical chamber 220. In some embodiments, the reflective inner surface 223 may collimate at least some of the light beams.

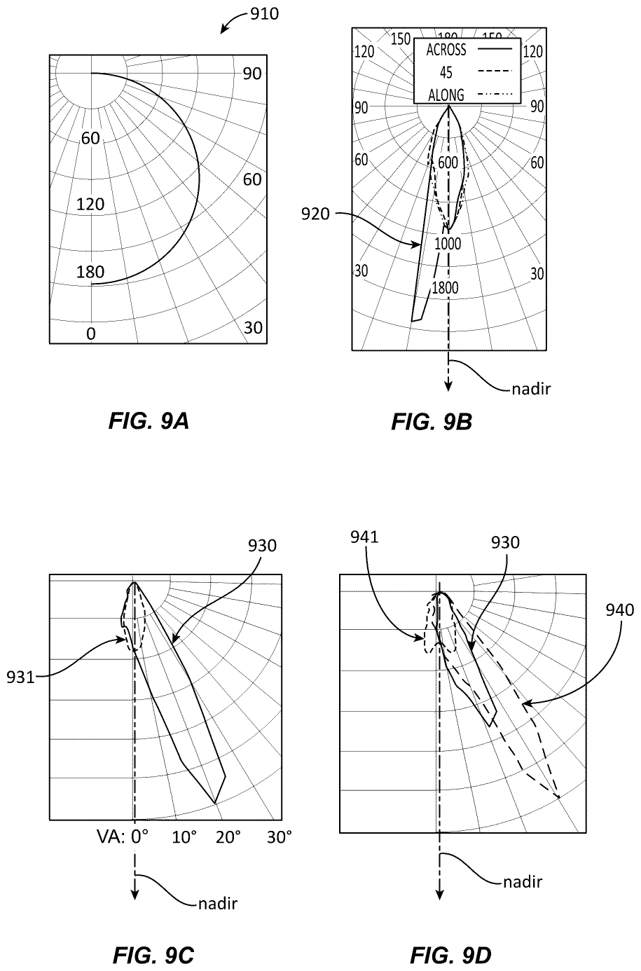

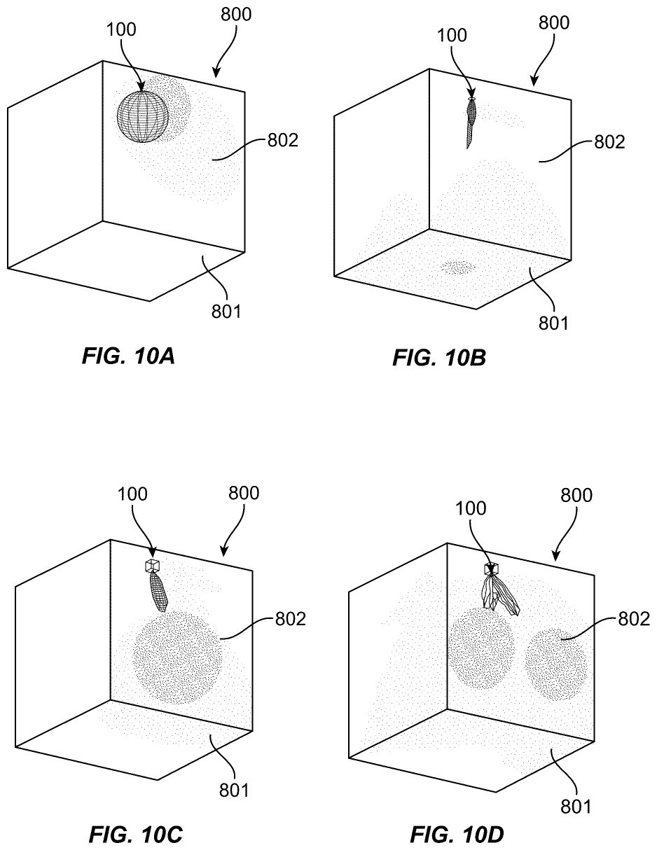

In some embodiments, the optical chamber 220 narrows and focuses light away from the target area (as shown in FIGS. 9B and 10B). However, the present disclosure is not limited to such optical chamber shapes. For example, the optical chamber 220 can be designed to direct light straight downwardly or towards the target area so that most of the light falls on to the first set of prisms 260 of the lens 250 at appropriate angles. Configuring the optical chamber 220 to aim the light towards the target area can aid the first set of prisms 260 of the lens 250 in its function of bending the light towards the target area.

In some embodiments, the reflector 210 with associated optical chamber 220 are formed integrally with the optical system housing 224 although in other embodiments they are a separate component that is secured within the optical system housing 224.

In some embodiments, the optical system housing 224 can be made of plastic (so as to be easily molded) or metal. The inner surface 223 of the optical chamber 220 can be a reflective film or paint deposited on the inner portion of the reflector 210 or a separate component coupled to the inner portion of the reflector 210. For example, the reflective material may be a metallic material with a highly polished inner surface for high reflectivity.

The optical system housing 224 can include coupling features configured to couple the optical system 200 with the heat sink 110 in a way the permits relatively quick and easy coupling and de-coupling of the two components. For example, as shown in FIGS. 1, 3, and 4A, the coupling features can include coupling flange(s) 215 (see FIGS. 1 and 4A) and coupling tab(s) 228. The coupling flanges 215 can be received within the cavity 111 of the heat sink 110 and coupled with a retention ring 115, as shown in FIGS. 2A and 3. For example, the coupling flanges 215 and retention ring 115 can form a twist and lock type attachment mechanism. In some embodiments, a spring-loaded strip 190 can be used to removably couple the heat sink 110 and the optical system housing 224. For example, as shown in FIG. 2A, the spring-loaded strip 190 can include a first end 191 and the second end 192. The first end 191 can be fastened via screws to the heat sink 110. The second end 192 can be removably coupled to the coupling tab 228 such that the optical system housing 224 can be decoupled from the heat sink 110. In some embodiments, attachment of the optical system 200 to the light engine 102 requires no tools (i.e., the optical system 200 is coupled to the light engine 102 via toolless engagement). In this way, optical system 200 can be easily installed onto and removed from light engine 102 and a different optical system (such as one that emits light only downwardly) can be interchangeably coupled to the already-installed heat sink 110 (and vice versa). Accordingly, a downlight optic or other optical system can be easily replaced or swapped out with the optical system 200 and vice versa without needing to remove the installed light engine 102 (e.g., including heat sink 110 and light sources 120).

The optical system housing 224 can further include a trim receiving portion 227 configured to receive a trim 300 (best seen in FIG. 3). The trim receiving portion 227 can extend from the optical chamber 200 and may have a symmetrical frustoconical shape (although other shapes are contemplated so long as the shape of the trim receiving portion 227 is compatible with the shape of the trim 300). The trim receiving portion 227 defines a third opening 229 that is located below the second opening 222 and that can have a larger diameter and/or area compared to first and second openings 221, 222. In some embodiments, the third opening 229 extends in a third plane substantially parallel to the first plane 221p of the first opening 221. In various embodiments, the coupling feature 228 can be provided on an outer surface of the trim receiving portion 227.

Referring to back to FIGS. 1 and 2A, the light fixture 100 can include the trim 300 adapted to be received and retained within the trim receiving portion 227 of the optical system housing 224. In some embodiments, the trim 300 can include a trim body 301 having a first trim opening 302 extending in a first trim opening plane and an opposing second trim opening 305 (see FIG. 2A) extending in a second trim opening plane that is oriented at an angle (such as angle θ₃ shown in FIG. 3) relative to the first trim opening plane. A trim flange 307 may extend outwardly from and/or around the second trim opening 305. The trim 300 can include a trim axis 325 passing through a center of the second trim opening 305. In some embodiments, the trim axis 325 may be parallel to or aligned with the optical axis 125 and/or the chamber axis 225.

In some embodiments, the circumferential edge of the first trim opening 302 can provide support for the lens 250. In this way, the trim 300 can provide an additional coupling means to angularly couple the lens 250 proximate the second opening 222 of the reflector 210. Likewise, the lens 250 will be angularly positioned relative to the second trim opening 305. The angle between the lens plane 250p and the second plane of the second trim opening 305 can be (but does not have to be) substantially same as the angle θ₃ (see FIG. 3). In some embodiments, at least a portion of the inner surface 300s of the trim 300 may be reflective (e.g., may include a reflective coating) to redirect light towards the target area. In some embodiments, however, an entirety of an inner surface 300s of the trim 300 may not be reflective. For example, the inner surface 300s of the trim proximate the target area may not be reflective to prevent reflecting light exiting from the light fixture 100 in a direction away from a target area (e.g., a wall portion).

The trim receiving portion 227 can be sized or adapted to securely couple the trim 300 to the optical system housing 224 so that the trim 300 does not fall under gravity when the light fixture 100 is installed. For example, the trim 300 can be coupled along the inner surface 227s of the trim receiving portion 227 via tight fit, snap fit features, or other coupling means.

Referring to FIGS. 4A-4B, the optical system housing 224 can include a lens receiving portion 230 configured to receive and support the lens 250 so that the lens 250 covers some or the entirety of the second opening 222. The lens receiving portion 230 can include a lens coupling surface 231. The lens coupling surface 231 can extend radially outward and at least partially along an edge of the second opening 222. When the lens 250 is received by the lens receiving portion 230, at least a portion of the lens 250 can abut against the lens coupling surface 231. The lens 250 can be larger in size than the second opening 222 such that the lens 250 covers the entire second opening 222. Accordingly, all of the light exiting the second opening 222 impinges on the lens 250. In some embodiments, the lens receiving portion 230 can have an inner surface 232 extending downward from the lens coupling surface 231 and along the inner surface 227s of the trim receiving portion 227. For example, the inner surface 232 can extend to a height H. In some embodiments, the inner surface 232 can provide some space for lens assembly and adjustments. For example, when assembling the lens 250, an angle of the lens 250 relative to the second opening 222 can be adjusted. The space around the lens receiving portion 230 can allow for pushing up the lens 250 and/or twisting and pulling of the trim 300 down for maintenance or replacement of the trim 300.

In some embodiments, the lens receiving portion 230 can include a coupling slot 233. The slot 233 extends radially outwardly and downwardly from the inner surface 232 and into the trim receiving portion 227. In some embodiments, the slot 233 can be configured to receive a coupling feature (e.g., a tab 257) of the lens 250. The slot 233 can serve as a guide to adjust an angle of the lens 250 relative to the second opening 222. The slot 233 can also prevent any radial displacement of the lens 250 when assembled.

In some embodiments, the lens 250 is retained within the optical system housing 224 such that the lens plane 250p and the second plane 222p of the second opening 222 of the reflector 210 are substantially parallel. However, as shown in FIG. 3, the lens plane 250p and the second plane 222p may not be parallel to each other. In some embodiments, the angle between the lens plane 250p and the second plane 222p (i.e., the difference between the angles θ₁ and θ₂ in FIG. 3) may be less than 30°, such as between 0° to 30°, inclusive. The difference in angles θ₁ and θ₂ may be a function of a diameter of the lens 250 and/or amount of travel (e.g., upward) of the lens 250 for assembling/disassembling of the lens and the trim.

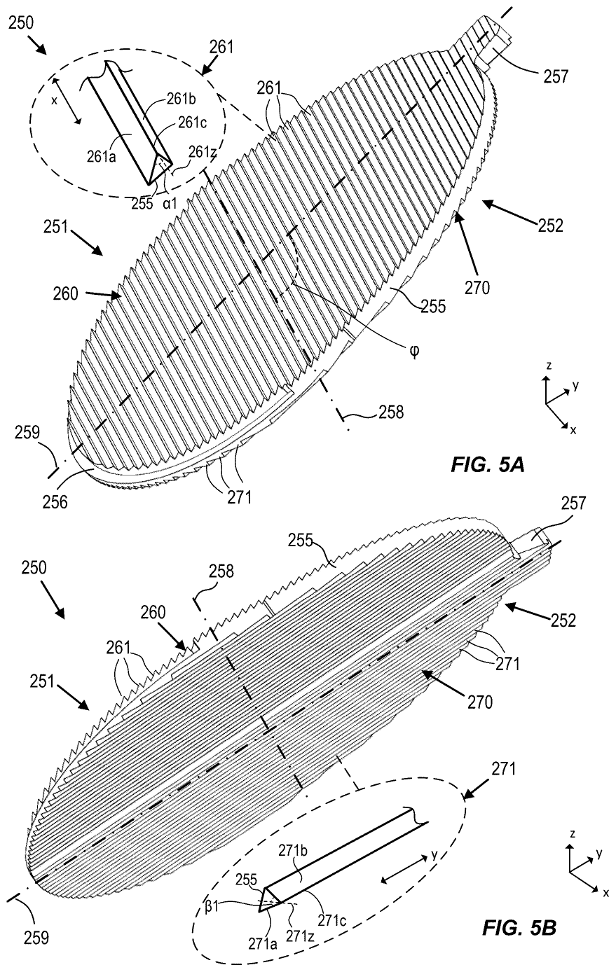

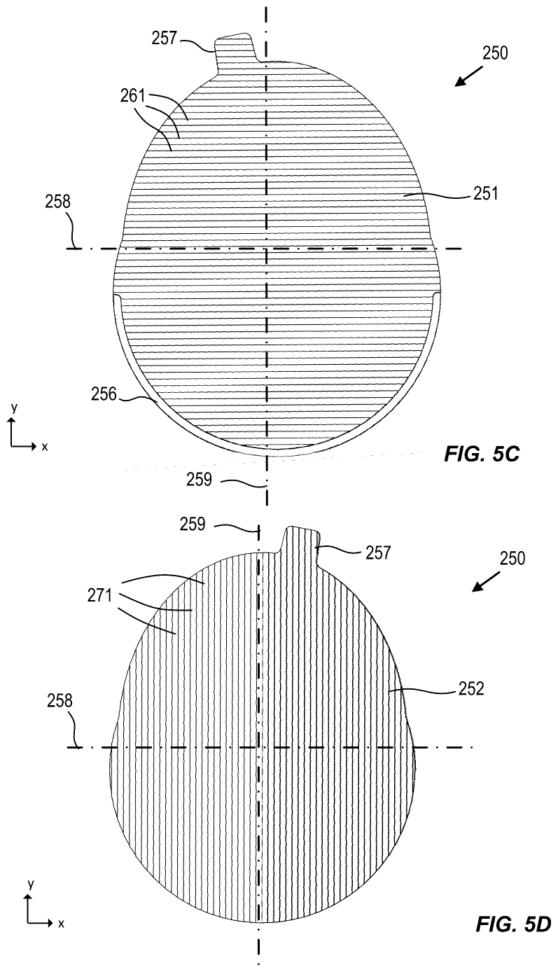

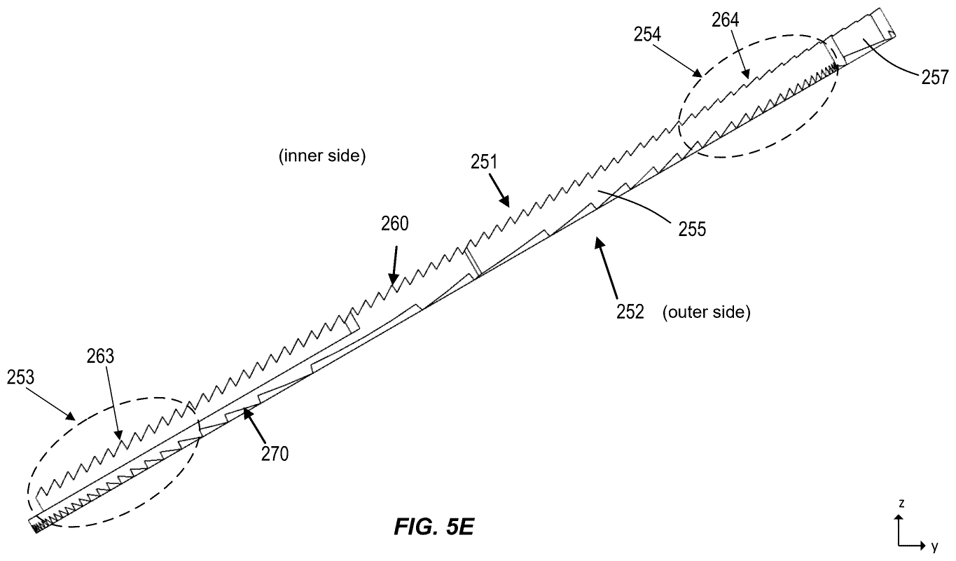

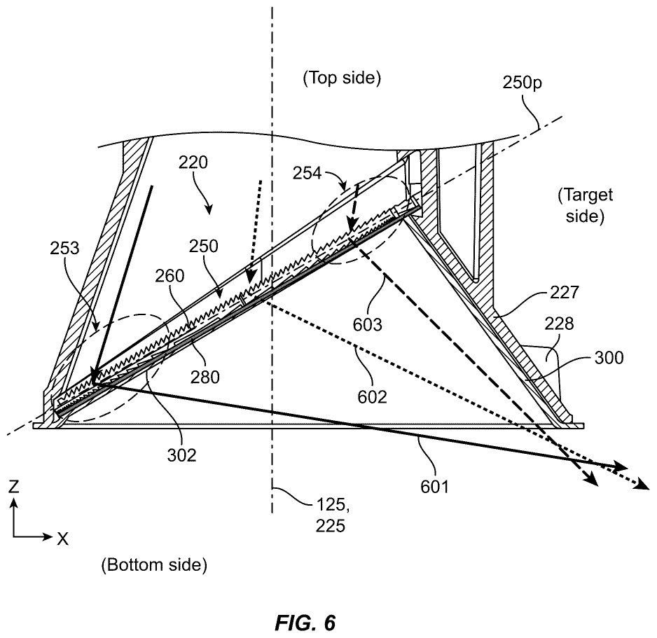

FIGS. 5A-5E illustrate a non-limiting example of the lens 250, and FIG. 6 illustrates light interacting with the lens 250. In various embodiments, the lens 250 can include a light input face 251 and an opposing light output face 252. The lens 250 can include a lens base 255 made of an optical material such as glass, silicone, plastic, etc. The light input face 251 and the light output face 252 can be opposite sides or faces of the lens base 255. The lens 250 can be configured to couple to the optical system housing 224 so as to be positioned to receive light from the second opening 222 of the optical chamber 220 such that the lens plane 250p is oriented at an angle θ₂ relative to the chamber axis 225, as best seen in FIGS. 3 and 6.

In various embodiments, the lens 250 can include a first set of prisms 260 and a second set of prisms 270 respectively configured to bend incident light in a specified direction (e.g., see FIG. 6) and to spread the bent light laterally across a target area. In various embodiments, the first set of prisms 260 can be provided on the light input face 251 and are configured to bend the light beams upwardly away from nadir and toward a target area. The second set of prisms 270 can be oriented at an angle relative to the first set of prisms 260 and are configured to spread the light beams laterally relative to the target area. For example, as shown in FIG. 6, the first set of prisms 260 can receive light from the optical chamber 220. The first set of prisms 260 are formed so as to bend the light upwardly relative to nadir and towards the target side. Then, the second set of prisms 270 can further laterally spread the light across the target area to create a uniform or evenly lit portion of the wall. As discussed below, the second set of prisms 270 can be provided on the light input face 251 and/or on the light output face 252 of the lens 250.

As shown in FIGS. 5A and 5B, in some embodiments the first set of prisms 260 can include a plurality of prisms 261 extending linearly along a first lens axis 258 and the second set of prisms 271 can include a plurality of prisms 271 extending linearly along a second lens axis 259 oriented at an angle φ relative to the first lens axis 258. In various embodiments, the angle φ between the first lens axis 258 and the second lens axis 259 may be substantially 90°. For example, substantially 90° may refer to a variation of less than ±5°. In some embodiments, the first lens axis 258 extends substantially perpendicular to the direction of the target area relative to the light fixture 100 when the light fixture 100 is in situ and/or the second lens axis 259 extends substantially parallel to the direction of the target area relative to the light fixture 100 when the light fixture 100 is in situ.

In the illustrated embodiment, the lens 250 has a substantially oval shape. In this case, the first lens axis 258 can be a minor axis of the oval shape, and the second lens axis 259 can be a major axis of the oval shape. As discussed herein, the lens 250 is not limited to a particular shape and other shapes such as rectangular, trapezoidal, etc. are possible. However, in some embodiments it is desirable (but not required) that the lens assume a shape that resists rotation within the optical chamber housing 224.

Referring to FIGS. 5A and 5B, each prism 261 of the first set of prisms 260 can be a substantially triangular prism. Similarly, each prism 271 of the second set of prisms 270 can be a substantially triangular prism. While it is believed that triangular-shaped prisms are most effective at bending the light as desired in applications disclosed herein, other prism shapes (e.g., pyramid, trapezoid, etc.) may be used.

A triangular prism can have a base and converging flat or curved faces extending angularly upwardly from the base. For example, as shown in an enlarged portion in FIG. 5A, the prism 261 includes a prism base (e.g., a portion of lens base 255) and side faces 261a, 261b extending angularly from the lens base 255. The side faces 261a and 261b have a prism angle α therebetween. In some embodiments, the prism angle α is between 0° and 60°, inclusive. In some embodiments, narrower ranges of prism angles are possible depending on an amount of bending of the light towards the target, geometry of the optical components, or other optical needs. The prism 261 can have an apex 261c at a height measured along the perpendicular 261z (e.g., along a z-direction).

Similarly, as shown in an enlarged portion in FIG. 5B, the prism 271 includes a prism base (e.g., a portion of lens base 255) and side faces 271a, 271b extending angularly from the lens base 255. The side faces 271a and 271b have a prism angle β1 therebetween. In some embodiments, prism angle β1 is between 0°and 60°, inclusive. The prisms 271 can have an apex 271c at a height measured along the perpendicular 271z (e.g., along a z-direction). In some embodiments, the apexes of prisms 261 and/or 271 are curved but they may also be pointed.

In various embodiments, the first set of prisms 260 can be distributed in a plurality of parallel rows and the second set of prisms 270 can be distributed in another plurality of parallel rows. For example, as shown in FIGS. 5C and 5D, the first set of prisms 260 are distributed in rows on the light input face 251, and the second set of prisms 270 are distributed in rows on the light output face 252. In FIG. 5C, the first set of prisms 260 are distributed in rows extending in the horizontal direction (e.g., x) within the lens plane (e.g., 250p). The second set of prisms 270 are distributed in rows extending in the vertical direction (e.g., y) within the lens plane (e.g., 250p). While all of the rows within the sets of prisms 260, 270 are illustrated as evenly spaced and parallel, such will not always be a requirement.

Individual prisms 261, 271 may be symmetrical or asymmetrical about the prism height (e.g., measured along 261z, 271z in FIS. 5A and 5B). As an example, a symmetrical prism may be an equilateral triangle such that an axis passing through the height of the prism divides the prism in two equal halves that are mirror images of each other. In contrast, an asymmetrical prism may be one having prism faces of different lengths and/or extending at different angles relative to the prism base.

The individual prisms 261, 271 within the first set of prims 260 and the second set of prisms 270, respectively, can be asymmetrical, symmetrical, or a combination of both. In some embodiments, at least some (if not all) of the prisms 261, 271 are asymmetrical about their height.

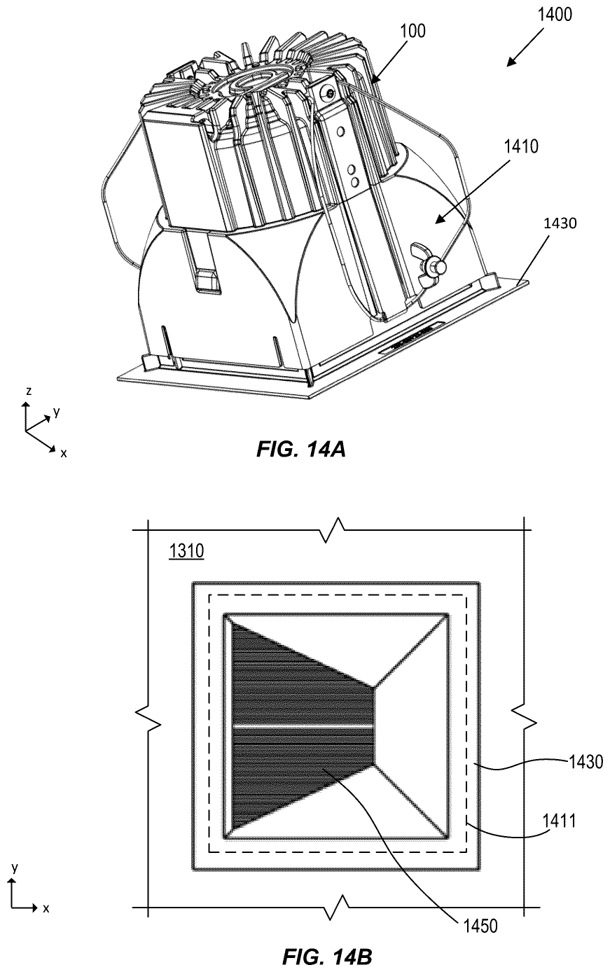

In some embodiments, the prism angles α of the first of prisms 260 are selected to bend the impinging light rays such that the light rays exit the first set of prisms 260 at an exit angle between 1° and 60°, inclusive, relative to nadir (or to the optical axis 125). Optimal prism angles α can be determined based on several factors, including but not limited to, the lens shape, number of prisms, prism pitch, lens manufacturing technique, a height H (see FIG. 4D) of the optical chamber 220, and/or a height of the trim 300. The prism angles can be applicable to oval shaped, square shape, rectangular shaped, or other lens shapes. Optimizing prisms angles for different lens geometries, different optical chamber heights, and/or trim heights not only provides manufacturing advantages, but also makes the lens 250 adaptable to different light fixtures. For example, a large lens sheet including the first set of prims 260 with prism angles α in a range from 0° to 60° can be manufactured. Then, portions of this large lens sheet can be cut to different shapes and sizes to be used with different types of light fixtures. For example, an oval shaped lens 250 and a trapezoidal shape lens (e.g., 1450 in FIG. 14B) can be cut from the same large lens sheet. This way, a lens (e.g., 250, 1450) for different light fixtures can be manufactured without having to design a lens for each light fixture separately. Thus, the lens herein can provide an economical and efficient lighting solution for different lighting applications.

Furthermore, the geometry of an optical chamber (e.g., 220) can affect the angles at which light is incident on the first set of prisms 260. The lens 250 can receive some light directly from the light source (e.g., 120) whereas other light is reflected by the reflective inner surface 223 of the optical chamber (e.g., 220) onto the lens 250. Hence, light may be incident at different angles on the lens 250. Advantageously, the prisms 261 of the first set of prims 260 can be designed such that even with the variations in incident light angles relative to the lens 250, the lens 250 can be effectively bend most of the light towards the target.

The geometry of the prisms 261 within the first set of prisms 260 can be, but in some embodiments are not, uniform across the light input face 251 of the lens 250 such that the light input face 251 of the lens 250 is asymmetric about the first lens axis 258. For example, the geometry of at least some of prisms 261 are different within the first set of prisms 260 such that the prisms 261 bend the light incident on the lens 250 at different angles and thereby ensure that a maximum amount of the light is able to exit the second trim opening 305 in a direction towards the target area. More specifically, the geometry of the prisms is designed such that the prisms more proximate the target area bend the light rays to a lesser degree relative to nadir than the prisms more distal the target area. The change in geometry of the prisms may be gradual across the lens or alternatively subsets of prisms may be provided across the lens whereby the geometry of prisms within a subset are identical but different between prism subsets.

For example and with reference to FIG. 5E, the first set of prisms 260 include a first subset of asymmetric prisms 263 located at a first end portion 253 (e.g., at a lower end) of the lens 250 and a second subset of asymmetric prisms 264 located at a second end portion 254 (e.g., an upper end) of the lens 250. The prism angles α of the first subset of asymmetric prisms 263 can be larger or greater than the second subset of asymmetric prisms 264. In some embodiments, the prism angles α within the subsets of asymmetric prisms 263, 264 can gradually decrease across the lens (such as from the lower end to an upper end of the lens 250 shown in FIG. 5E). In this way, light beams impinging upon the second end portion 254 are bent to a lesser degree than light beams impinging upon the first end portion 253 so as to exit the lens or light fixture at smaller exit angles relative to nadir (or to the optical axis 125). For example, at the upper end portion, the prism angles α within the second subset of asymmetric prisms 264 can be in a range from 0° to 60°, inclusive. Similarly, at a lower end portion, the prism angles α within the first set of asymmetric prisms 263 can be in a range from 0° to 60°, inclusive.

Although the asymmetric prisms of the first set of prisms 260 are described to have different prism angles, other ways of achieving asymmetry about the first lens axis 258 are possible. For example, the prisms can have different heights. As illustrated in FIG. 5E, the height of the first subset of asymmetric prisms 263 is greater than the height of the second subset of asymmetric prisms 264. Moreover, the pitch of the prisms, and/or number of prisms may be varied. In some embodiments, the asymmetry about the first lens axis 258 indicates that prisms on opposing sides of the first lens 258 are not mirror images of each other.

Referring to FIG. 6, the lens 250 is mounted at an angle relative to the chamber axis 225 such that the first set of asymmetric prisms 263 are located at a lower end and the second set of asymmetric prisms 264 are located at an upper end of the second opening 222 of the optical chamber 220. The lens axis 258 (in FIG. 5A) extends approximately perpendicular to the direction of the target area relative to the light fixture and thus approximately perpendicular to the direction of the light exiting the fixture toward the target area. The lens 250 is designed such that light exiting the lens more distal the target area exits the lens at larger exits angles relative to nadir than the light exiting the lens more proximate the target area.

FIG. 6 illustrates a simplified ray diagram to show how the light is bent by prisms 261, with a light ray 601 exiting a prism of the first subset of prisms 263, a light ray 602 exiting a prism at a center portion of the lens 250, and a light ray 603 exiting a prism of the second subset of prisms 264. While all of light rays 601-603 are directed towards the target side, light ray 601 exits the lens 250 at an angle relative to nadir (or to the optical axis 125) that is greater than either of the exit angles of light rays 602 and 603. This exit angle difference permits virtually all (e.g., more than 85%) of the light rays to “clear” the trim 300 and exit from the light fixture 100 in a direction toward the target side. Thus, by varying the geometry of the prisms 261 (prism angles, prism heights, prism pitch, number of prisms, etc.), the lens 250 can be optimized for high optical efficiency and utilization.

The first set of prisms 260 establish the exit angle of the light from the lens 250 and bend the light towards the target area. In some embodiments, the first set of prims 260 bend the light such that it exits the light fixture 100 at an angle in the range from 1° to 45° relative to nadir (or to the optical axis 125). This bend angle can be a function of the geometry of the light fixture, the optical chamber, a diameter of the lens 250, opening size of the trim, or other geometry of light fixture components.

The second set of prisms 270 serve to spread that directed light across the target area within minimal to no additional bending of the light. In some embodiments, the prisms 271 of the second set of prisms 270 can be individually asymmetrical but the geometry of the prims 271 can be the same within the second set of prisms 270 (e.g., all of the prisms 271 have the same prism height, prism angle, etc.) can be preferably symmetrical about the second lens axis 259. For example, prisms on one side of the lens axis 259 can be mirror images of prisms on the opposite side of the lens axis 259.

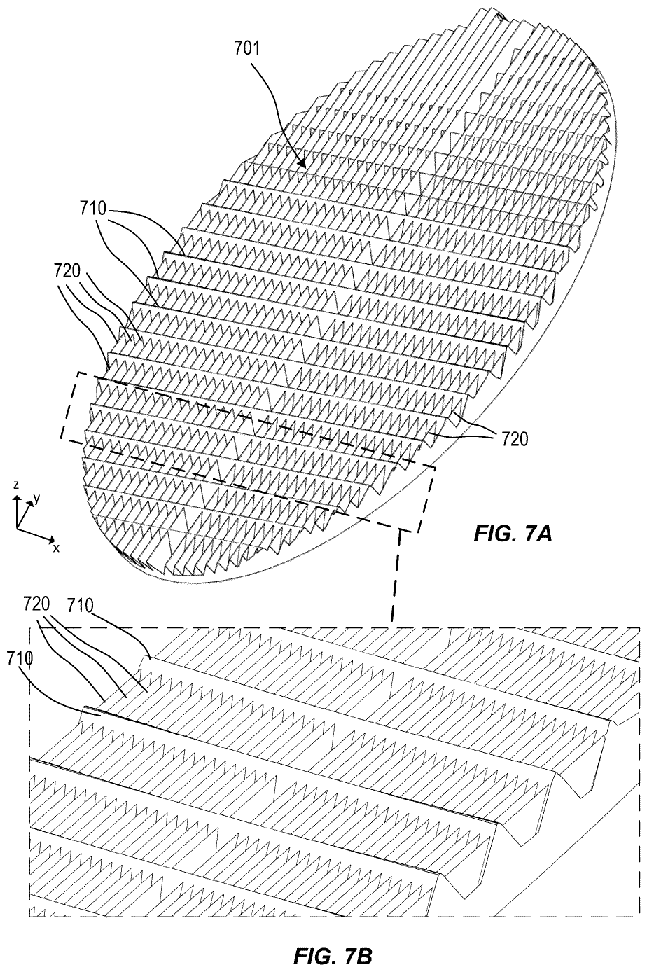

FIGS. 7A and 7B illustrate another example of a lens 700 having two sets of prisms provided on a light input face 701. In this illustrated embodiment, the lens 700 includes a first set of prisms 710 and a second set of prisms 720. The first set of prisms 710 can be distributed in a plurality of rows, and the second set of prisms 720 extend between and at an angle to adjacent prisms in the first set of prisms 710. As seen in FIG. 7B, the first set of prisms 710 can extend linearly along a first direction (e.g., along x-axis). The second set of prisms 720 can be discrete sets of prisms located between two adjacent prisms of the first set of prisms 720. The second set of prisms 720 are oriented along a second direction (e.g., along y-axis). While the first set of prisms 710 and the second set of prisms 720 are illustrated as extending perpendicular relative to each other, such might not always be the case. The angle between the two sets of prisms 710 and 720 may be in a range between 0° to 90°

In some embodiments, some or all of the prisms of the first set of prisms 710 can have a height greater than the height of some of all of the prisms of the second set of prisms 720. In some embodiments, the heights of some or all the second set of prims 720 can be substantially the same as the prisms 710. The height of each prism can be measured perpendicularly from a base of a prism to a peak of the prism (e.g., similar to as shown in FIG. 5A). The lens 700 can perform similarly as lens 250. Accordingly, the geometry of the first set of prisms 710 can be similar to that of the first set of prisms 260 and the geometry of the second set of prisms 720 can be similar to that of the second set of prisms 270. By way only of a narrow, non-limiting example, the prisms of the first set of prisms 710 and the second set of prisms 720 may be asymmetrical and the geometry of the prisms of the first set of prisms 710 may vary across the lens (e.g., similar to first and second prism subsets 263, 264 discussed with respect to FIG. 5E) whereas the geometry of the prisms of the second set of prisms may be identical.

The lens 250, 700 may be formed of any suitable optical material, including but not limited to, glass, silicone, optical grade polymeric materials (e.g., polymethylmethacrylate (PMMA) or polycarbonate (PC)), etc. In various embodiments, the prisms may be integrally formed with the lens base 255. For example, the lens may be molded with the prisms or the prisms may be embossed into the lens base 255. In some embodiments, the prisms can be formed on a film that is subsequently attached to the lens base 255. In some embodiments, a large sheet bearing the prisms can be manufactured and one or more discrete lenses cut from the large sheet in the desired lens shape and size. However, the present disclosure is not limited to a prism forming process and other processes may be used.

In various embodiments, the lens 250 can include coupling features compatible with lens mounting features provided in the optical system housing 224 (see FIG. 4A). As shown in FIGS. 5A and 5B, the coupling features can include a flat surface 256 and a tab 257. The flat surface 256 can indicate the end of the prism portion of the lens 250 and may be used for lens handling so that prisms do not get damaged during coupling of the lens 250 with the optical system housing 224. The tab 257 can be sized and shaped to be received in the slot 233 of the optical system housing 224. The tab 257 can facilitate assembly and specified orientation of the lens 250 within the optical system housing 224. Moreover, when the tab 257 is positioned in the slot 233, a rotational and/or radial movement of the lens 250 relative to the optical system housing 224 can be restricted. The tab 257 may have flat upper and bottom surfaces or may include prisms thereon. The prisms on the tab 257 do not affect or distort the light distribution exiting the lens 250. The coupling features 256 and 257 can be formed at opposite ends of the lens 250. The present disclosure is not limited to a type of coupling feature and other type of coupling features are possible. For example, the lens 250 can be coupled using fasteners, adhesive or other coupling means associated with a lens.

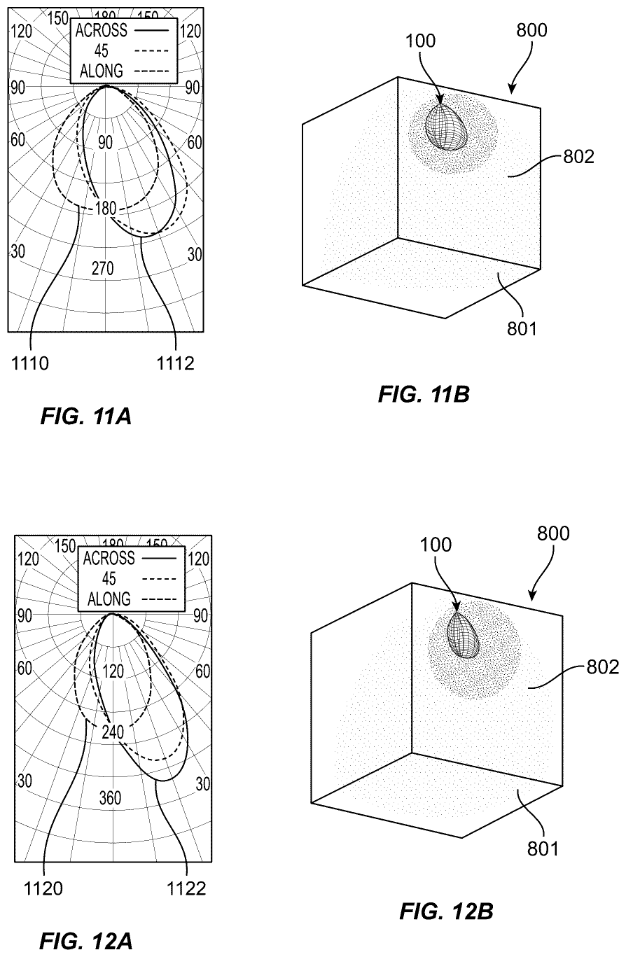

In various embodiments, a diffuser 280 may be provided on the lens 250, e.g., as shown in FIGS. 1, 3 and 6. The diffuser 280 can be a film provided on or adjacent the light output face 252 of the lens 250. In some embodiments, the diffuser 280 is a film adhesively attached to the light output face 252 or formed directly on the light output face 252. The diffuser 280 can diffuse the light exiting the lens 250. For example, the diffuser 280 can reduce an intensity of the light and make the light distribution smoother across a target area (e.g., a wall portion). In various embodiments, the diffuser 280 can be coupled to or formed on the second set of prisms 270 (if present) on the light output face 252. The diffuser 280 can be a film configured to control the brightness of the light to produce a soft lighting effect. In FIG. 3, the diffuser film 280 is formed on the second set of prisms 270 on the light output face 252. Due to the diffuser film 280, the second set of prisms 270 are not clearly visible in FIG. 3. The lighting effects imparted by the diffuser 280 are further discussed with respect to FIGS. 11B and 12B, which provide a visual understanding of how the diffuser 280 softens the light output from the lens 250 (e.g., FIG. 10D).

The light fixture 100 herein is a non-limiting example employing the optical system 200. The optical system 200 can be adapted to different light fixtures and/or trims without limiting the scope of the present disclosure. For example, the optical system 200 can be configured to have different shapes (e.g., oval, round, rectangular, square (see FIGS. 14A-14B), or other geometric shapes). In some embodiments, the optical system 200 can be configured to be interchangeable onto a downlight fixture designed to direct light downwardly rather than at an angle. For example, an existing light fixture arrangement can be converted to a different lighting solution (e.g., a wall wash type of light fixture) by replacing the downlight optical system with the optical system discussed herein that casts and distributes light at an angle to nadir (i.e., creates an asymmetrical light distribution). This can be done in the field without the need to remove and/or replace an existing light engine (e.g., including heat sink/light sources) already mounted within the ceiling.

In various embodiments, a light fixture (e.g., 100) may be a recessed downlight fixture. Using the optical system (e.g., 200) herein, the light fixture can be configured to provide a wall wash lighting to evenly illuminate a portion of the wall. Examples of light effects and light distributions associated with the optical system 200 is further discussed with respect to FIGS. 8A-8B through 12A-12B below. In FIGS. 8A, 10A-10D, 11B, 12B, illumination patterns are shown in dot patterns. A dense dot pattern (e.g., seen as a spot) indicates where a majority of the light is focused. These dense dot patterns or focused light portions generally show light distribution achieved via the components of the optical system 200. A less dense or more sparse dot pattern indicates ambient light or some light from the light fixture generally spreading in a space upon exiting a light fixture.

FIG. 8A illustrates a wall portion illuminated using the light fixture 100 employing an embodiment of optical system 200 including a lens 250 with two sets of angularly oriented prisms 260, 270. The light fixture 100 can be installed within a room 800 having a floor 801, a wall 802, and a ceiling (omitted to show the light fixture 100). A lighting solution may involve illuminating a wall portion 803 located closer to the ceiling. As shown, the light fixture 100 can be located at a distance D from the wall 802 and prisms of the lens 250 oriented such that the first set of prisms 260 extend parallel to the wall (first lens axis 258 runs parallel to the wall 802 and the second set of prisms 270 extend perpendicular to the wall 802 (second lens axis 259 run perpendicular to the wall 802). The optical system 200 may be used to create a uniform or even light distribution onto the wall portion 803. The light distribution is more clearly illustrated in a polar plot in FIG. 8B.

In the polar plot of FIG. 8B, a first light distribution 810 corresponds to light spread parallel to the wall and the second light distribution 820 corresponds to light aimed toward the wall. In other words, first light distribution 810 represents the light distribution looking directly at the wall and second light distribution 820 represents the light distribution directed towards the wall viewed from the side of the fixture. Optical system 200 not only bends the light towards the wall, but also evenly spreads the light along a portion of the wall.

FIGS. 9A-9D illustrate polar plots of light distributions associated with each component of the optical system 200. The corresponding lighting effects within a room or a space is illustrated in FIGS. 10A-10D, respectively, for visually understanding of the concepts without limiting the scope of the present disclosure.

FIG. 9A illustrates a light distribution 910 associated with the light source (e.g., 120 in FIG. 1). As shown, the light distribution 910 is an example of a wide Lambertian distribution. The corresponding lighting effect of such light distribution 910 is shown in FIG. 10A. In FIG. 10A, the light spread to the wall 802, an adjacent wall, as well as the floor 801 of the room 800 or space 800.

Referring to FIG. 9B, when the light from the light source (e.g., 120) is directed through the optical chamber (e.g., 220) of the optical system (e.g., 200), the light distribution 910 is converted to a narrower and focused light distribution 920. Furthermore, due to the offset conical structure of the optical chamber (e.g., 220 in FIG. 3), the light distribution 920 is shifted towards left of nadir. As shown in FIG. 10B, the light distribution 920 causes the light to be directed away from the wall 802 or portion 803 and towards the floor 801. This light distribution 920 is received by the first set of prisms (e.g., 260) of the lens (e.g., 250).

As shown in FIG. 9C, the first set of prisms (e.g., 260) bends the light towards the right side of nadir and towards the wall 802 with the wall portion 803 desired to be illuminated. Thus, the first set of prisms create a light distribution 930. As shown, the first set of prisms (e.g., 260) may bend the light by between 10° to 30° from nadir. However, the first set of prisms do not create a wider spread parallel to the wall, as shown by the light distribution 931. For example, FIG. 10C, the first set of prisms (e.g., 260) bends the light towards the wall 802, but may not uniformly illuminate the wall 802. This light distribution 930 is further spread by the second set of prisms (e.g., 270) of the lens (e.g., 250).

As shown in FIG. 9D, the second set of prisms (e. g, 270) can create a light distribution 940 which is clearly angled towards the wall and has a larger spread compared to the light distribution 930 created by the first set of prisms. Furthermore, the second set of prisms spreads the light parallel to the wall as illustrated by a batwing shaped light distribution 941. As seen, the light distributions 940 and 941 are more spread out in at least two directions (e.g., horizontal and vertical) compared to the light distribution 930. In some cases, the second set of prisms (e.g., 270) may further bend the light, but only negligibly (e.g., less than 5°). The lighting effect of these light distributions 940, 941 is shown in FIG. 10D. As shown, the second set of prisms (e.g., 270) more uniformly spreads the light across the wall 802. This way, the wide light distribution 910 from the light source (e.g, 120) can be converted to an angular and laterally spread-out distributions 940, 941 via the optical system (e.g., 200) herein.

FIGS. 11A-11B and FIGS. 12A-12B illustrate employing different types of diffusers to fine tune or soften the batwing nature of light distribution 941 to create a more uniform light distribution 1110, 1120 on the target area (wall 802). For example, referring to, FIG. 11A, a first type of diffuser (an example of the diffuser 280) may be designed to diffuse a 55° horizontal batwing distribution, which can be characterized by an angle between two lobes of the batwings. As such, when a batwing type of distribution from the lens 250 passes through the diffuser, a uniform distribution 1110 is created. For example, when the light exiting the second set of prims 270 passes through the first diffuser (e.g., 280), it converts a batwing distribution 941 (in FIG. 9D) and the angled distribution 940 (in FIG. 9D) to smoother distributions 1110, 1112, respectively. For example, as shown in FIG. 11B, the lighting effect is clearly smoother, and more uniform compared to the lighting effect shown in FIG. 10D without the diffuser.

Similarly, referring to FIG. 12A, a second type of diffuser (e.g., 280) may be used to smooth out an approximately 30° rotational light distribution When light from the second set of prims 270 of the lens passes through the second diffuser (e.g., 280) smoother light distributions 1120, 1122 corresponding to light distribution 941, 940, respectively are created. For example, as shown in FIG. 12B, the lighting effect is clearly smoother, and more uniform compared to the lighting effect shown in FIG. 10D without the diffuser.

In comparison, the distribution 1120 is slightly narrower compared to distribution 1110. However, the visual difference between the lighting effects (e.g., 11B and 12B) created with different diffusers is minimal to negligible. In other words, using different diffusers is possible without significantly deviating from the light distribution created by the lens 250.

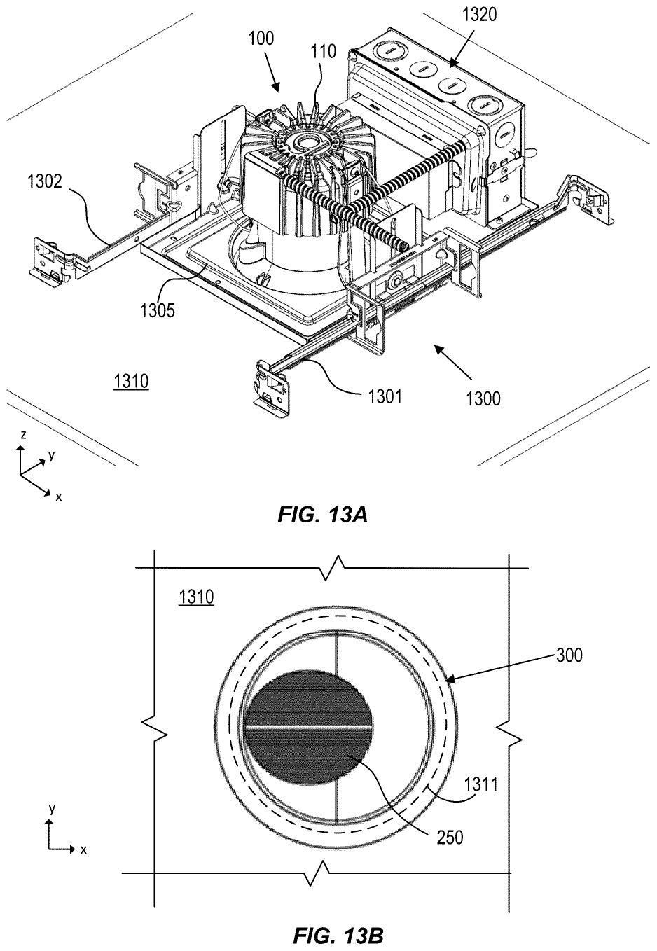

FIG. 13A illustrates a top perspective view of the light fixture 100 coupled to a ceiling 1310. The light fixture 100 can include the optical system 200, as discussed herein. FIG. 13B illustrates a bottom view of the light fixture 100 when viewed by a person looking upward towards the ceiling 1310. As shown in FIG. 13B, the ceiling 1310 can include a hole 1311 to receive the light fixture 100 such that the trim 300 and lens 250 is visible while most of the light fixture assembly is hidden above the ceiling 1310.

Referring to FIG. 13A, the light fixture 100 can be coupled using a mounting structure 1300 and powered via a power supply 1320. The mounting structure 1300 can include brackets 1301, 1302 spaced from each other. The heat sink 110 of the light fixture 100 can be supported in a pan 1305 that is secured to the brackets 1301, 1302. This way, the light fixture 100 is primarily positioned behind the ceiling using the mounting structure 1300. Once the light fixture 100 is installed, the mounting structure 1300 can stay in place and may not be readily removable. With this mounting structure 1300, it can be appreciated that interchangeability of the optical system 200 herein can be particularly beneficial as the entire light fixture and mounting structure need not be removed from the ceiling 1310. The optical system 200 can be easily accessed and removed from the below the ceiling 1310. In some embodiments, the optical system 200 can be replaced by a downlight optical system thereby converting the light fixture to a downlight fixture for lighting room space and/or floor area.

FIGS. 14A-14B illustrate another example of a light fixture 1400 including an optical system 1410 coupled to a ceiling 1310. The optical system 1410 may have a rectangular chamber, rather than a frustoconical chamber. Accordingly, the optical system 1410 can be adapted to have a rectangular profile and include components similar to the optical system 200 discussed herein. For example, the optical system 1410 can include a lens 1450, which can be similar to the lens 250 except being rectangular or trapezoidal in shape, as seen in FIG. 14B. Similar to the lens 250, the lens 1450 can include a first set of prisms (e.g., similar to the prisms 260) and a second set of prisms (e.g., similar to the prisms 270) configured to bend and uniformly spread the light from the light sources (e.g., 120 in FIG. 1). Accordingly, the lens 1450 can bend the light in a similar manner as discussed with respect to the lens 250 herein. The light fixture 1400 can include the heat sink 110 and a square trim 1430. The heat sink 110 can be coupled to the ceiling 1300 in a similar manner as shown in FIG. 13A. The ceiling 1310 can include a square hole 1411 to receive the optical system 1410 such that when view from below, the square trim 1430 and lens 1450 are visible while remaining components are hidden behind ceiling 1310. The optical system 1410 can be accessed and replaced from the bottom of the ceiling 1310, shown in FIG. 14B. This way, a different optical system adapted for a square or other shapes can be interchangeably coupled to the mounting structure (e.g., 1300 in FIG. 13B).

In the present disclosure, different types of “light sources” such as LED or other PCB mounted light sources, CFL light sources, fluorescent light sources, incandescent light sources, or the like can be used without limiting the scope of the present disclosure. For example, the “light sources” can be an LED light engine, which can be an integrated assembly composed of one or more light emitting diodes (LEDs) or LED arrays (modules), as well as an LED driver and other optical, thermal, mechanical and electrical components. The light sources can be configured to have a custom form factor. For example, the custom form factor can include variable dimensions (e.g., a variable width dimension, variable height dimension and variable depth dimension), shapes (e.g., rectangular, square, circular), or other available form factors of a lighting fixture.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics can be combined in any suitable manner in one or more embodiments. Further, it is intended that embodiments of the disclosed subject matter cover modifications and variations thereof.

It is to be understood that terms such as “top,” “bottom,” “front,” “side,” “length,” “lower,” “interior,” “inner,” “outer,” and the like that can be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Different arrangements of the components depicted in the drawings or described above, as well as components and steps not shown or described are possible. Similarly, some features and subcombinations are useful and may be employed without reference to other features and subcombinations.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. An optical system adapted to direct towards a target area light rays from a light source having an optical axis, the system comprising:
a reflector defining an optical chamber comprising an upper opening, a lower opening, a chamber axis extending between the upper opening and the lower opening, and a reflective inner surface, wherein the upper opening is adapted to receive the light rays and the reflective inner surface is adapted to direct the light rays towards the lower opening; and
a lens extending within a lens plane oriented at a first angle relative to the chamber axis, the lens comprising:
a light input face;
a light output face opposite the light input face;
a first set of prisms provided on the light input face and configured to bend the light rays such that the light rays exit the lens at an exit angle relative to the optical axis and in a direction towards the target area; and
a second set of prisms oriented at a second angle relative to the first set of prisms and configured to spread the light rays laterally relative to the target area.

2. The optical system of claim 1, wherein each prism of the first set of prisms extends linearly along a first lens axis, and each prism of the second set of prisms extends linearly along a second lens axis oriented at the second angle relative to the first lens axis.

3. The optical system of claim 1, wherein the second angle is substantially 90°.

4. The optical system of claim 1, wherein the second set of prisms is provided on the light output face of the lens.

5. The optical system of claim 1, wherein the second set of prisms is provided on the light input face of the lens.

6. The optical system of claim 5, wherein the first set of prisms are distributed in a plurality of rows, and the second set of prisms extend between and at the second angle between adjacent prisms of the first set of prisms.

7. The optical system of claim 1, wherein the exit angle is between 1° and 60°, inclusive, relative to the nadir.

8. The optical system of claim 1, wherein the first set of prisms are asymmetrical about a first lens axis extending through a center of the lens in a first direction, and wherein each prism of the first set of prisms and each prism of the second set of prisms comprises a prism height and a prism angle and wherein at least some prisms of the first set of prisms are asymmetrical about their height.

9. The optical system of claim 8, wherein the second set of prisms are symmetrical about a second lens axis extending through the center of the lens in a second direction, and wherein at least some prisms of the second set of prisms are asymmetrical about their height.

10. The optical system of claim 8, wherein the prism height and the prism angle of each prism of the second set of prisms are identical.

11. The optical system of claim 8, wherein at least one of the prism height or the prism angle is different between a first prism subset of the first set of prisms and a second prism subset of the first set of prisms such that the first and second prism subsets are configured to bend the light rays at different angles.

12. The optical system of claim 8, wherein the prism angle of each prism of the first set of prisms and of the second set of prisms is greater than 0° and less than and including 60°.

13. The optical system of claim 1, wherein the optical chamber has a frustoconical shape that is asymmetrical about the chamber axis.

14. The optical system of claim 13, wherein the lower opening of the optical chamber extends in a plane that is angled relative to the chamber axis.

15. The optical system of claim 13, wherein the optical chamber is asymmetrical about the chamber axis and comprises, in cross-section, a first chamber sidewall and an opposing second chamber sidewall that is longer than the first chamber sidewall.

16. The optical system of claim 15, wherein the first chamber sidewall and the second chamber sidewall extend at different angles relative to the chamber axis.

17. The optical system of claim 1, wherein the reflective inner surface of the optical chamber is configured to at least partially collimate the light.

18. The optical system of claim 1, further comprising a diffusing film provided on the light output face of the lens.

19. The optical system of claim 1, wherein the chamber axis is adapted to extend parallel to the optical axis.

20. The optical system of claim 1, wherein the optical axis and the chamber axis are colinear.

21. The optical system of claim 1, wherein the upper opening of chamber extends in a first plane that is angled relative to a second plane of the lower opening, wherein the angle between the first plane and the second plane is in a range between 0° to 50°, inclusive.
